(19) United States
(12) Patent Application Publication
(10) Pub. No.: US 2012/0082915 A1
(43) Pub. Date: Apr. 5, 2012

(54) Polymer Electrolyte Membrane Fuel Cell

(75) Inventors: Masaya Kozakai, Hitachinaka (JP); Tsutomu Okusawa, Hitachi (JP)

(73) Assignee: Hitachi, Ltd., Tokyo (JP)

(21) Appl. No.: 13/228,140

(22) Filed: Sep. 8, 2011

(30) Foreign Application Priority Data
Sep. 30, 2010 (JP) 2010-220255

(51) Int. Cl. H01M 8/04; H01M 8/24

(52) U.S. Cl. 429/437; 429/457

(57) ABSTRACT

A polymer electrolyte membrane fuel cell of the present invention has a simple structure in a cooling part and is small. The polymer electrolyte membrane fuel cell includes a membrane electrode assembly, a porous gas flow field for anode which is conductive and supplies fuel gas, a porous gas flow field for cathode which is conductive and supplies oxidant gas, and a bipolar plate which separates the fuel gas flow field and the oxidant gas flow field. Channels are formed in a surface of the porous gas flow field for cathode, the surface facing the bipolar plate. Preferably, plural concave portions are provided in at least one surface of flow field walls forming the channels. Preferably, the oxidant gas is mixed with cooling water and the mixture is supplied to the porous gas flow field for cathode.

### CLAIM OF PRIORITY

The present application claims priority from Japanese Patent Application JP 2010-220255 filed on Sep. 30, 2010, the content of which is hereby incorporated by reference into this application.

### FIELD OF THE INVENTION

The present invention relates to a fuel cell which generates electric energy by a chemical reaction of hydrogen and oxygen.

### BACKGROUND OF THE INVENTION

A polymer electrolyte membrane fuel cell includes a membrane electrode assembly and gas diffusion layers. The membrane electrode assembly includes a polymer electrolyte membrane, a fuel electrode catalyst layer (hereinafter referred to as an anode) covering one surface of the polymer electrolyte membrane, and an oxidant electrode catalyst layer (hereinafter referred to as a cathode) covering another surface of the polymer electrolyte membrane. The gas diffusion layers ark made of a porous carbon material and disposed on both surfaces of the membrane electrode assembly. Bipolar plates, which supply fuel gas and oxidant gas, are arranged on surfaces of the gas diffusion layers to configure a power generation unit cell. A fuel cell stack is configured by forming a stack of plural power generation unit cells and by fastening the both ends of the stack with an endplate or the like.

The bipolar plate is generally provided with a flow field of fuel gas or oxidant gas on one surface and a flow field of cooling medium on the other surface, and is prepared by, for example, forming a concavity and convexity in a thin metal plate by press process. In a fuel cell using this bipolar plate, a convex surface (hereinafter referred to as a rib) of a fuel gas flow field in the anode side and a rib of an oxidant gas flow field in the cathode side are in contact with the gas diffusion layers. At this contact part, electrons generated by the reaction is given and received, and heat generated by the electrochemical reaction is transferred to the cooling medium flowing through the cooling flow field. The fuel gas or the oxidant gas flows through concave parts and is supplied to the electrode catalysts through the gas diffusion layers.

Practical applications of the fuel cell have been progressed for dispersed power sources for stationary use and power sources for automobile use because the fuel cell has high efficiency compared with other power sources and has low environmental burden. For example, a high power density fuel cell such as being smaller and lighter is required in the case of automobile use. For this purpose, uniform power generation throughout a power generation surface and reduction in components which do not directly contribute to the power generation are required. In a conventional a bipolar plate, a reaction gas flow field is formed by pressing thin metal plate. In this case, functions of each part of the bipolar plate are separated. For example, a rib in contact with the gas diffusion layer only serves as current-carrying section and a flow field only serves as gas diffusion. As a result, distribution of the current-carrying section and the gas diffusion part is generated depending on a size of the ribs and a width of the flow field. Reducing the size of the ribs and a width of the flow field is effective for uniform power generation. However, such reduction has limitation from the viewpoint of processing.

Instead of such a pressed bipolar plate, a method of using a conductive porous medium having communicated fine pores can be considered as a reaction gas flow field. When the porous medium is used, a metal skeleton part of the porous medium acting as a current-carrying section and fine pores acting as a gas diffusion part can be mixed and uniformized. Thereby, reaction for the uniform power generation is achieved and improvement in power output can be expected.

However, there is also limitation for producing a high power density fuel cell by only using a porous medium for the reaction gas flow field. For producing a fuel cell having a higher power density, it is required that high cooling density is developed in a cooling medium flow field which is a part other than the reaction gas flow field and the number of a cooling part is reduced in the fuel cell stack. Particularly, if the cooling part and the power generation part can be integrated, a more compact fuel cell can be produced. For example, when cooling water is simultaneously introduced with reaction gas into the reaction gas flow field, cooling effect is obtained by evaporating the cooling water due to heat generated by the electrochemical reaction and removing evaporative latent heat.

As a method for supplying water into reaction gas, Japanese Patent Application Publication No. 2007-87805 discloses a method for introducing fine water droplets generated by high-pressure jet spray of water into the reaction gas.

In the method for introducing fine water droplets disclosed in Japanese Patent Application Publication No. 2007-87805, each power generation unit cell has a mechanism for introducing the fine water droplets. Therefore, uniform cooling is expected in each cell. However, a small fuel cell system is difficult to produce due to increase in auxiliary machines and driving power, because spraying water at high pressure is required for forming the fine water droplets.

The present invention is developed by considering these problems, and aims to provide a fuel cell which has a simple structure of a cooling part and therefore is small.

### SUMMARY OF THE INVENTION

A polymer electrolyte membrane fuel cell of the present invention includes a stack of power generation unit cells. Each of the power generation unit cells includes a membrane electrode assembly; a conductive gas diffusion layer supplying fuel gas to an anode of the assembly; a conductive porous medium provided with a fuel gas flow field; a conductive gas diffusion layer supplying oxidant gas to a cathode of the assembly; a conductive porous medium provided with an oxidant gas flow field; and a bipolar plate separating the fuel gas flow field and the oxidant gas flow field. The polymer electrolyte membrane fuel cell of the present invention has following characteristics.

1) The conductive porous medium forming the oxidant gas flow field includes channels in a surface facing the bipolar plate.
2) Preferably, concave portions are provided in at least one surface of flow field walls of the channels included in the conductive porous medium.
3) Preferably, the concave portions are larger in size than a surface roughness of the conductive porous medium.
4) Preferably, intervals of the concave portions lying upstream are shorter than intervals of the concave portions lying downstream along a direction of a gas flow.
5) Preferably, the bipolar plate is hydrophilic at least a surface in contact with the conductive porous medium forming the oxidant gas flow field.
6) Preferably, the reaction gas flow fields (the fuel gas flow field and the oxidant gas flow field) is formed by communicated fine pores of the conductive porous medium, and the oxidant gas flow field supplies the oxidant gas and cooling water mixed with the oxidant gas to the oxidant electrode of the assembly.

According to the present invention, the reaction gas flow field being formed by the porous medium and the channels being provided in the surface in contact with the bipolar plate, a surface facing a membrane electrode assembly can be in contact with the porous medium throughout the surface, the reaction gas is supplied to the whole surface of electrode catalyst through the fine pores of the porous medium, and electrons can transfer in a metal part of the porous medium. Therefore, the reaction is possible at the whole surface of the electrode. Because cooling water is mixed into the oxidant gas and cooling is performed by evaporative latent heat, the amount of the cooling water and the number of cooled cells can be reduced, and thereby a thinner fuel cell stack can be produced.

### BRIEF DESCRIPTION OF THE DRAWINGS

FIG. 1 is a schematic view of a partial cross section of a unit cell of a fuel cell in accordance with a first embodiment of the present invention;

FIG. 2 is a schematic view of a fuel cell drawn by using a surface including the channels of the gas flow field of the porous media as a standard, and dashed lines show a projection of a bipolar plate including manifolds which supply and exhaust reaction gas;

FIG. 3 is another schematic view of a fuel cell drawn by using a surface including the channels of the gas flow field of the porous media as a standard, and dashed lines show a projection of a bipolar plate including manifolds which supply and exhaust reaction gas;

FIG. 4 is another schematic view of a fuel cell drawn by using a surface including the channels of the gas flow field of the porous media as a standard, and dashed lines show a projection of a bipolar plate including manifolds which supply and exhaust reaction gas; and

FIG. 5 is a schematic view of a configuration of a fuel cell stack and system of the fuel cell in accordance with an embodiment of the present invention.

### DETAILED DESCRIPTION OF THE PREFERRED EMBODIMENTS

Hereinafter, fuel cells in accordance with embodiments of the present invention are described using the drawings.

### First Embodiment

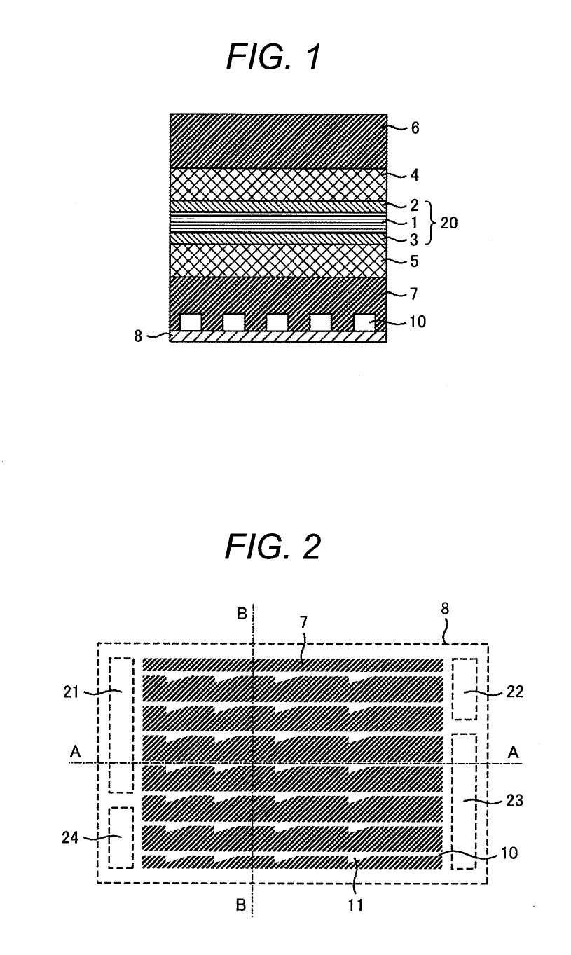

FIG. 1 is a schematic view showing a part of a cross section of a unit cell of a fuel cell in accordance with a first embodiment of the present invention. The cross section is perpendicular to a flow direction of a reaction gas. More specifically, the cross section is a part of B-B cross section shown in FIG. 2. The unit cell includes a membrane electrode assembly 20, a gas diffusion layer 4 for anode, a gas diffusion layer 5 for cathode, a porous flow field 6 for anode, a porous flow field 7 for cathode, and a bipolar plate 8, which are disposed outside of the membrane electrode assembly 20. The membrane electrode assembly 20 is configured by a polymer electrolyte membrane 1, and an anode 2 and a cathode 3 of catalyst layers, the anode 2 and the cathode 3 being disposed on both surfaces of the polymer electrolyte membrane 1. It is possible to omit the gas diffusion layers by integrating functions of the gas diffusion layers into the porous flow fields. Although not shown in FIG. 1, the unit cell is provided with a sealing member for preventing leakage of reaction gas and cooling water. Hereinafter, description is made under the condition that a fuel gas is hydrogen and an oxidant gas is air. However, hydrogen-rich gas is usable for the fuel gas and oxygen is the best for the oxidant gas.

The polymer electrolyte membrane 1 is made of a fluorine-based or hydrocarbon-based solid polymer material. The anode 2 and the cathode 3 are configured by a carbon support on which a catalyst, such as platinum, is supported and electrolyte (binder) for providing proton conductivity. The gas diffusion layers 4 and 5 are configured by carbon paper or carbon felt in which carbon fiber is bound. The membrane electrode assembly 20 used in the embodiments can endure an operating temperature of the fuel cell of 80° C. or more, desirably 90° C. or more.

The bipolar plate 8 separates the fuel gas flow field and the oxidant gas flow field. The bipolar plate 8 is made of a dense metal plate of pure metal or alloy having a thickness of 0.2 mm or less. Alternatively, the bipolar plate 8 is made of a cladding material which is made by stacking and rolling the plurality of such a metal plate. Examples of materials of the metal plate include titanium, SUS, aluminum, and magnesium.

The porous flow field 6 for anode and the porous flow field 7 for cathode are porous media made of metal materials. The metal materials are selected from a group of titanium, aluminum, magnesium, nickel, chromium, molybdenum, and an alloy including these metals, such as SUS. The porous media are made by foaming, sintering, or binding fine metal fibers and include communicated fine pores having a porosity of 75% or more and having a pore diameter of 200 μm or more.

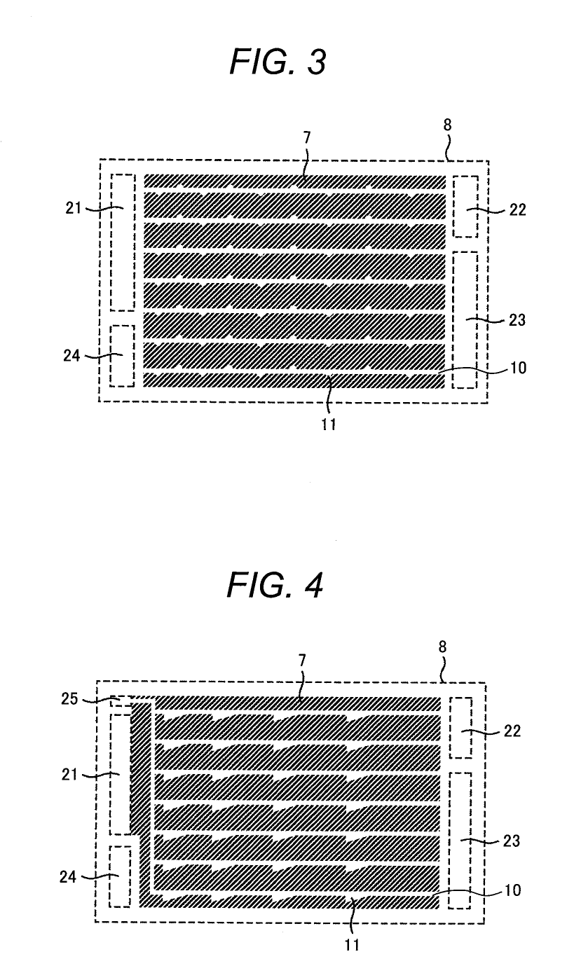

In the porous flow field 7 for cathode, plural cathode channels 10 are formed in the surface facing the bipolar plate 8. The cathode channels 10 have larger cross-sectional area than the pore diameter of the porous medium. In at least one surface of the flow field walls made of the porous medium of the cathode channels 10, a plurality of concave portions 11 are formed. These concave portions 11 can have various shapes which can be processed, not only shapes shown in FIG. 2 and FIG. 3. A method for forming the cathode channels 10 and the concave portions 11 includes, for example, a method for using a mold having a shape of the channels at the time of producing the porous medium and a method for performing press process or cutting process after producing the porous medium. In FIG. 2, the cathode channels 10 have a linier shape along a direction of a gas flow from an oxidant gas supply manifold 21 to an oxidant gas exhaust manifold 23. However, the cathode channels 10 can have a shape including a curved line or curved lines, not limited to the linier shape.

In the cathode channels 10, cooling water supplied with air, which is a reaction gas, flows from the oxidant gas supply manifold 21 illustrated by a dashed line in FIG. 2. The reaction gas can be effectively supplied to the cathode 3 due to a flow of the oxidant air through the fine pores of the porous flow field 7 for cathode.

In order to uniformly distribute the cooling water which is supplied into a plurality of cathode channels 10 to the power generation surface, rectification parts, which are not illustrated in the drawings, can be disposed at outlet and inlet parts of the cathode channels 10. The amount of the supplied cooling water is determined depending on an electrode area and operation current density, and is set so that the evaporative latent heat can cool at least the heat generated by power generation.

Oxidant air mixed with the cooling water is introduced into the porous flow field 7 for cathode and the cathode channels 10 configured by the porous medium. The heat generated by power generation is conducted from the membrane electrode assembly 20 to the porous flow field 7 for cathode. The supplied cooling water is evaporated by contacting with a porous medium skeleton part of metal which forms the porous flow field 7 for cathode. At this time, cooling in the reaction gas can be achieved because the evaporative latent heat is removed from the skeleton of the porous medium. The fuel cell according to the embodiment needs a porous flow field which can enlarge specific surface compared with a conventional channel structure.

A part of the cooling water introduced into the cathode channels 10 evaporates, cooling the cell by the evaporative latent heat, and at the same time another part of the cooling water is retained in the concave portions 11. When an operation condition of the fuel cell is rapidly changed, the water retained in the concave portions 11 can be used for a part in which the amount of water flowing in a flow field is insufficient. Relative humidity is higher and the generated water is easier to condense as going downstream in the oxidant gas flow field. Moreover, the generated water is easier to dry as going upstream in the oxidant gas flow field. Consequently, it is desirable that the concave portions are more densely arranged at an upstream position than a downstream position of the oxidant gas flow field. The concave portions 11 are formed to be larger in size than a surface roughness of the porous medium in order to ensure the retention capacity of the water.

When a large part of the supplied cooling water is introduced into the porous flow field 7 for cathode, gas diffusion may be inhibited. By giving hydrophilic treatment to the surface in contact with the porous flow field 7 for cathode of the bipolar plate 8, the introduced cooling water can be easier to attach to the bipolar plate 8 and easier to flow in the cathode channels 10.

Evaporated vapor is exhausted from the oxidant gas exhaust manifold 23 with residual reaction gas. By this operation, the fuel cell can be maintained at a predetermined temperature without separately having a cooling cell. Therefore, this operation is effective for producing a small fuel cell.

Particularly, when the operating temperature of the fuel cell is set to 90° C. or more, it is expected that the fuel cell can be cooled only by cooling effect of the evaporative latent heat. Therefore, the amount of the supplied cooling water mixed into the reaction gas can be dramatically reduced compared with a conventional fuel cell using sensible heat generated by circulating cooling medium in an independently disposed cooling cell.

As in this embodiment, deviation of distribution of the cooling water can be decreased in the power generation surface and generation of non-uniformity of cooling can be prevented by disposing the concave portions 11 in the cathode channels 10 to retain the cooling water.

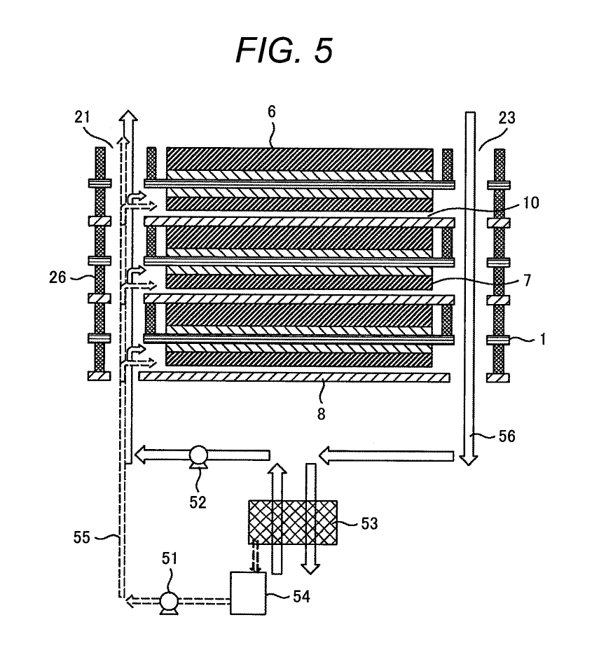

FIG. 5 is a cross-sectional view showing a part of a fuel cell stack according to the present invention, and shows A-A cross section of a stack of the bipolar plates in FIG. 2. Each of the cells in the stack includes a polymer electrolyte membrane 1, an anode on an upper surface of the polymer electrolyte membrane 1, and a cathode on a lower surface of the polymer electrolyte membrane 1 in FIG. 5, similar to the cell in FIG. 1. The stack in FIG. 5 includes plural sub-stacks which are piled up. Each of the sub-stacks includes a porous flow field 6 for anode, a gas diffusion layer 4 for anode, a membrane electrode assembly 20, a gas diffusion layer 5 for cathode, a porous flow field 7 for cathode, and a bipolar plate 8 from the top to the bottom. A seal 26 prevents leakage of the reaction gas to outside and interfusion of the fuel gas and the oxidant gas around the manifolds. The membrane electrode assembly 20 has electrode catalyst applied on a power generation part, not on a peripheral part of the manifolds and a part which the seal 26 is in contact with.

A gas supply system to the fuel cell stack includes an oxidant gas blower 52 for supplying oxidant air, a piping system which connects a cooling water injection pump 51 supplying cooling water into the oxidant air and an oxidant gas supply manifold 21, and another piping system for exhausting unreacted gas and vapor from an oxidant gas exhaust manifold 23. Supply of fuel is performed by using a blower or pressure of a hydrogen tank, although a fuel system is not shown in FIG. 5.

The air supplied from the oxidant gas blower 52 is supplied to the oxidant gas supply manifold 21 after merging the cooling water supplied from the cooling water injection pump 51 at some point of the pipe. The oxidant gas and the cooling water are supplied to each cell by the manifold. As described in the description of FIG. 1, temperature in the cell can be kept constant by evaporation of the cooling water. Exhaust gas is exhausted from the oxidant gas exhaust manifold 23 through pipes of the exhaust system.

The cooling water can be externally supplied. However, water generated in the power generation reaction can be effectively used by condensing vapor in the exhaust gas with a heat exchanger 53, accumulating the condensed vapor in a condensed water recovery tank 54, and reusing the accumulated water. This method for reusing the water can make the system compact.

In the case of the embodiment described above, the reaction gas flow field being formed by the porous medium and the channels 10 being provided in the surface in contact with the bipolar plate 8, surfaces facing the gas diffusion layers which sandwich the membrane electrode assembly 20 can be in contact with the porous medium throughout the surface, and the reaction gas is supplied to the whole surface of the electrode catalyst. Therefore, uniform reaction is possible at the whole surface of the electrode catalyst. Because cooling water is mixed into the oxidant gas and cooling is performed by evaporative latent heat, the amount of the cooling water and the number of cooled cells can be reduced, and thereby a thinner fuel cell stack can be produced.

### Second Embodiment

FIG. 4 shows a schematic plan view showing a structure of a bipolar plate including a porous flow field of a fuel cell in accordance with a second embodiment of the present invention. This view illustrates a fuel cell drawn by using a surface including the channels of the gas flow field of the porous media as a standard, and dashed lines show a projection of a bipolar plate including manifolds which supply and exhaust reaction gas.

In this embodiment, a bipolar plate 8 includes a cooling water supply manifold 25 on the same side as an oxidant gas supply manifold 21. When cooling by evaporative latent heat is performed, an amount of cooling water is small compared with an amount of oxidant gas. Therefore, the cooling water supply manifold 25 has a smaller shape compared with the oxidant gas supply manifold 21 depending on the amounts of the cooling water and the oxidant gas. The cooling water supply manifold 25, which is disposed at a corner of the bipolar plate 8 in FIG. 4, may be provided between the oxidant gas supply manifold 21 and a fuel gas exhaust manifold 24.

One of the cathode channels 10 is connected to the cooling water supply manifold 25 and the cooling water is introduced into the cathode channels 10. In order to supply the cooling water to the whole area of the cells, the cathode channels 10 disposed in the porous flow field 7 for cathode include channels from the oxidant gas supply manifold 21 to the oxidant gas exhaust manifold 23 and channels connecting adjacent channels. FIG. 4 shows an example of a structure in which one of the cathode channels 10 is disposed in the porous flow field 7 for cathode and diverges from the cooling water supply manifold 25. The structure of the cathode channels 10 is not limited to the structure in FIG. 4, as long as the cooling water is supplied to the whole area of the power generation surface. The oxidant gas supply manifold 21, through which only the oxidant air flows, is connected to only the porous flow field 7 for cathode.

In this configuration, the oxidant gas and the cooling water can be separated in the manifolds and can be independently supplied into each cell. Moreover, the cooling water mainly flows through the cathode channels 10 because the cathode channels 10 are connected only to the cooling water supply manifold 25.

According to this embodiment, the cooling water, which is supplied into the oxidant gas in the stack, can be equally supplied into the cells.

According to these embodiments described above, the fuel cell is provided which is small and can appropriately maintain the cell temperature at the time of an operation in high current density by performing effective cooling in the cathode gas flow field.

What is claimed is:

1. A polymer electrolyte membrane fuel cell including a stack of power generation unit cells, each of the power generation unit cells comprising:
a membrane electrode assembly;
a fuel gas flow field formed of a conductive porous medium, the fuel gas flow field supplying fuel gas to a fuel electrode of the assembly;
an oxidant gas flow field formed of a conductive porous medium, the oxidant gas flow field supplying oxidant gas to an oxidant electrode of the assembly; and
a bipolar plate separating the fuel gas flow field and the oxidant gas flow field;
wherein the conductive porous medium forming the oxidant gas flow field includes channels in a surface facing the bipolar plate.

2. The polymer electrolyte membrane fuel cell according to claim 1,
wherein the bipolar plate is hydrophilic at least a surface in contact with the conductive porous medium forming the oxidant gas flow field.

3. The polymer electrolyte membrane fuel cell according to claim 2,
wherein concave portions are provided in at least one surface of flow field walls of the channels, the flow field walls forming the channels included in the conductive porous medium forming the oxidant gas flow field.

4. The polymer electrolyte membrane fuel cell according to claim 3,
wherein the concave portions provided in the conductive porous medium are larger in size than a surface roughness of the conductive porous medium.

5. The polymer electrolyte membrane fuel cell according to claim 3,
wherein intervals of the concave portions lying upstream are shorter than intervals of the concave portions lying downstream along a direction of a gas flow.

6. The polymer electrolyte membrane fuel cell according to claim 1,
wherein the oxidant gas flow field supplies the oxidant gas and cooling water to the oxidant electrode of the assembly, the cooling water being mixed with the oxidant gas.
